(19) United States
(12) Patent Application Publication
(10) Pub. No.: US 2008/0300353 A1
(43) Pub. Date: Dec. 4, 2008

(54) LASER SINTER POWDER WITH METAL SOAPS, PROCESS FOR ITS PRODUCTION, AND MOLDINGS PRODUCED FROM THIS LASER SINTER POWDER

(75) Inventors: Sylvia MONSHEIMER, Haltern am See (DE); Maik GREBE, Bochum (DE); Franz-Erich BAUMANN, Duelman (DE); Joachim MUEGGE, Haltern am See (DE); Wolfgang CHRISTOPH, Marl (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA AG, Duesseldorf (DE)

(21) Appl. No.: 12/131,425

(22) Filed: Jun. 2, 2008

Related U.S. Application Data
(63) Continuation of application No. 10/637,637, filed on Aug. 11, 2003, now abandoned.

(30) Foreign Application Priority Data
Nov. 28, 2002 (DE) 102 55 793.4
Jul. 7, 2003 (DE) 103 30 591.2

(51) Int. Cl. C08K 5/00; B29C 35/08

(52) U.S. Cl. 524/394; 264/497

(57) ABSTRACT

A sinter powder containing a polyamide and metal soaps, in particular particles of a salt of an alkanemonocarboxylic acid. A process for laser sintering, and to moldings produced from the sinter powder. The moldings formed using the powder have advantages in appearance and in surface finish when recyclability in the selective laser sintering (SLS) process is taken into account. Moldings produced from recycled sinter powder have improved mechanical properties, in particular in the modulus of elasticity and tensile strain at break.

### BACKGROUND OF THE INVENTION

1. Field of the Invention

The invention relates to a laser sinter powder containing a polyamide, preferably nylon-12 and which comprises metal soap (particles), a process for producing the powder, and moldings produced by selective laser sintering of the powder.

2. Description of the Related Art

Very recently, a need for the rapid production of prototypes has arisen. Selective laser sintering is a process particularly well suited to rapid prototyping. In this process polymer powders are selectively irradiated briefly in a chamber with a laser beam. Particles of the powder exposed to the laser beam melt. The molten particles fuse and solidify to give a solid mass. Three-dimensional bodies can be produced simply and rapidly by repeatedly applying fresh layers of polymer powder and exposing the fresh layers to the laser beam.

The process of laser sintering (rapid prototyping) to produce moldings made from pulverulent polymers is described in detail in U.S. Pat. No. 6,136,948 and WO 96/06881 (both of which are incorporated herein by reference in their entireties). A wide variety of polymers and copolymers are disclosed to be useful in this application, including polyacetate, polypropylene, polyethylene, ionomers, and polyamide.

Nylon-12 powder (PA 12) has proven particularly successful in industry for laser sintering to produce moldings, in particular to produce engineering components. The parts manufactured from PA 12 powder meet high requirements with regard to mechanical loading, and have properties nearly the same as those of parts mass produced by production techniques such as extrusion or injection molding.

A PA 12 powder well suited for the invention has a median particle size (d₅₀) of from 50 to 150 μm, and is obtained for example as in DE 197 08 946 or DE 44 21 454 (both of which are incorporated herein by reference in their entireties). It is preferable to use a nylon-12 powder whose melting point is from 185 to 189° C., whose enthalpy of fusion is 112 kJ/mol, and whose freezing point is from 138 to 143° C., as described in EP 0 911 142 (incorporated herein by reference in its entirety).

The polyamide powders currently used in laser sintering can lead to the formation of depressions and rough surfaces on the moldings. These arise when unsintered material is reused. This results in the need to add a high proportion of fresh powder, known as virgin powder, to eliminate these defects.

The depression effect is particularly evident when large proportions of recycled or reused powder are used. Recycled powder is laser sinter powder which has been included in a sinter process at least once before but not melted during any previous use. Surface defects are often associated with impairment of mechanical properties, particularly if a rough surface is generated on the molding. The deterioration in mechanical properties can become apparent in a lowering of the modulus of elasticity, impaired tensile strain at break, and/or an impaired nod impact performance.

### SUMMARY OF THE INVENTION

Accordingly, it is an object of the present invention to provide a laser sinter powder which has better resistance to the thermal stresses that arise during laser sintering, better aging properties, and better recyclability.

Surprisingly, it has now been found that the addition of metal soaps to polyamides can produce sinter powders which can be used in laser sintering to produce moldings which, when compared with moldings prepared from conventional sinter powders, are markedly less sensitive to the thermal stresses arising during sintering. This permits, for example, a marked reduction in the rate of addition of fresh material, i.e. in the amount of virgin powder which has to be added when using recycled powder. It is particularly advantageous when the amount which has to be added is equal to the amount consumed by the formation of the molding. This can (almost) be achieved using the powder of the invention.

The present invention therefore provides a sinter powder for selective laser sintering which comprises at least one polyamide and at least one metal soap selected from the salts of a fatty acid having at least 10 carbon atoms, salts of a montanic acid, or salts of a dimer acid.

The present invention also provides a process for producing the sinter powder of the invention, which comprises mixing at least one polyamide powder with metal soap particles to give a sinter powder, either in a dry process or in the presence of a solvent in which the metal soap has at least low solubility, and then removing the dispersing agent or solvent. In both embodiments the melting points of the metal soaps are above room temperature.

The present invention also provides moldings produced by laser sintering of polymer powders which comprise metal soap and at least one polyamide.

An advantage of the sinter powder of the invention is that moldings produced by laser sintering the powder can also be produced from recycled material. This permits production of moldings which have no depressions even after repeated reuse of the excess powder. A very rough surface due to aging of the material is a phenomenon which is known to occur in conventional sintering processes together with depressions. The moldings of the invention have markedly higher resistance to these aging processes, as reflected in low embrittlement, good tensile strain at break, and/or good notched impact performance.

Another advantage of the sinter powder of the invention is that it performs well when used as a sinter powder even after heat aging. This performance enhancement is readily possible because, for example, during the heat-aging of the powder of the invention, surprisingly, no decrease in recrystallization temperature can be detected, and in many instances a rise in recrystallization temperature can be detected (the same also frequently applies to the enthalpy of crystallization of the powder). When an aged powder of the invention is used to form a structure (e.g., a molding) the crystallization performance achieved is almost the same as when virgin powder is used. When conventional powder is aged, it crystallizes at temperatures markedly lower than the crystallization temperature of virgin powder. This results in the formation of depressions when recycled powder is used to form structures from conventional powder.

Another advantage of the sinter powder of the invention is that it may be mixed in any desired amount (from 0 to 100 parts) with a conventional laser sinter powder based on polyamides of the same chemical structure. The resultant powder mixture likewise shows better resistance than conventional sinter powder to laser sintering thermal stresses.

Surprisingly, it has also been found that, even on repeated reuse of the sinter powder of the invention, moldings produced from this powder have consistently good mechanical properties, in particular with regard to modulus of elasticity, tensile strength, density, and tensile strain at break.

### DETAILED DESCRIPTION OF THE INVENTION

The sinter powder of the invention and a process for its production, are described in detail below without intention of further limitation.

The inventive sinter powder for selective laser sintering comprises at least one polyamide and at least one metal soap preferably selected from the salts of a fatty acid having at least 10 carbon atoms, salts of montanic acid, or salts of a dimer acid. The polyamide present in the sinter powder of the invention is preferably a polyamide which has at least 8 carbon atoms per carboxamide group. The sinter powder of the invention preferably comprises at least one polyamide which has 9 or more carbon atoms per carboxamide group. The sinter powder very particularly preferably comprises at least one polyamide selected from nylon-6,12 (PA 612), nylon-11 (PA 11), and nylon-12 (PA 12). The polyamide may be regulated i.e., terminal group modified or unregulated (unmodified).

The sinter powder of the invention preferably comprises a polyamide whose median particle size is from 10 to 250 μm, preferably from 45 to 100 μm, and particularly preferably from 50 to 80 μm.

A particularly suitable powder for laser sintering is a nylon-12 sintering powder which has a melting point of from 185 to 189° C., preferably from 186 to 188° C., an enthalpy of fusion of 112±17 kJ/mol, preferably from 100 to 125 kJ/mol, and a freezing point of from 133 to 148° C., preferably from 139 to 143° C. The process for preparing the polyamides is well-known and, for example in the case of nylon-12, preparation can be found in the specifications DE 29 06 647, DE 35 10 687, DE 3510 691, and DE 44 21 454 (each of these incorporated herein by reference in their entireties). The polyamide pellets are commercially available from various producers, an example being nylon-12 pellets with the trade name VESTAMID supplied by Degussa AG.

The sinter powder of the invention preferably comprises, based on the entirety of the polyamides present in the powder, from 0.01 to 30% by weight of at least one metal soap, preferably from 0.1 to 20% by weight of the metal soap, particularly preferably from 0.5 to 15% by weight of metal soap, and very particularly preferably from 1 to 10% by weight of metal soap, in each case preferably in the form of particles. The sinter powder of the invention may comprise a mixture of metal soap particles and polyamide particles, and/or may comprise metal soaps incorporated into polyamide particles or into polyamide powder. If the proportion of the metal soaps, based on the entirety of the polyamides present in the powder is less than 0.01% by weight, the desired effect of thermal stability and resistance to yellowing is markedly reduced. If the proportion of the metal soaps based on the entirety of the polyamides present in the powder is above 30% by weight, there is a marked impairment of mechanical properties, e.g. tensile strain at break of moldings produced from these powders.

The metal soaps present in the sinter powder of the invention are preferably salts of linear saturated alkanemonocarboxylic acids whose chain length is from C10 to C44 (chain length from 10 to 44 carbon atoms), preferably from C24 to C36. Particular preference is given to the use of calcium salts or sodium salts of saturated fatty acids, or those of montanic acids. These salts are obtainable at low cost and are readily available.

For applying the powder to the layer to be sintered it is advantageous if the metal soaps encapsulate the polyamide particles in the form of very fine particles. This can be achieved either via dry-mixing of finely powdered metal soaps with the polyamide powder, or by wet-mixing polyamide dispersions in a solvent in which the metal soaps have at least low solubility. Particles modified in this way have particularly good flowability, and there is no need, or very little need, for the addition of flow aids. However, it is also possible to use powders into which metal soap has been incorporated by compounding in bulk if another method is used to ensure flowability e.g. inclusion of a flow aid by mixing. Suitable flow aids are known to the person skilled in the art, examples include fumed aluminum oxide, fumed silicon dioxide, or fumed titanium dioxide.

The sinter powder of the invention may therefore comprise flow aids and/or other auxiliaries, and/or fillers. Examples of auxiliaries include the abovementioned flow aids, e.g. fumed silicon dioxide, and/or precipitated silicas. An example of a fumed silicon dioxide is supplied by Degussa AG with the product name AEROSIL®, with various specifications. The sinter powder of the invention preferably comprises less than 3% by weight, with preference from 0.001 to 2% by weight, and very particularly preferably from 0.05 to 1% by weight, of these auxiliaries, based on the total amount of the polyamides present. Examples of the fillers include glass particles, metal particles, or ceramic particles, e.g. solid or hollow glass beads, steel shot, or metal granules, or color pigments, e.g. transition metal oxides.

The filler particles preferably have a median particle size which is smaller or approximately equal to that of the particles of the polyamides. The extent to which the median particle size d₅₀ of the fillers exceeds the median particle size d₅₀ of the polyamides should preferably be not more than 20%, with preference not more than 15%, and very particularly preferably not more that 5%. The particle size is limited by the overall height or thickness of the layer in the laser sintering apparatus.

The sinter powder of the invention preferably comprises less than 75% by weight, with preference from 0.001 to 70% by weight, particularly preferably from 0.05 to 50% by weight, and very particularly preferably from 0.5 to 25% by weight of fillers based on the total amount of the polyamides present.

If the amount of the auxiliaries and/or fillers is greater than 30%, depending on the filler or auxiliary used, moldings produced using these sinter powders can have marked impairment of mechanical properties. Further, a disruption of the powder's intrinsic absorption properties of laser light may result in the powder no longer being useful for selective laser sintering.

After heat-aging of the sinter powder of the invention, there is preferably no shift in its recrystallization temperature (recrystallization peak in DSC) and/or in its enthalpy of crystallization towards values smaller than those for the virgin powder. Heat-aging means exposure of the powder for from a few minutes to two or more days to a temperature in the range from the recrystallization temperature to a few degrees below the melting point. An example of typical artificial aging may take place at a temperature equal to the recrystallization temperature plus or minus approximately 5 K, for from 5 to 10 days, preferably for 7 days. Aging during use of the powder to form a structure typically takes place at a temperature which is below the melting point by from 1 to 15 K, preferably from 3 to 10 K, for from a few minutes to up to two days, depending on the time needed to form the particular component. In the heat-aging which takes place during laser sintering, powder on which the laser beam does not impinge during the formation of the layers of the three-dimensional object is exposed to temperatures of only a few degrees below melting point during the forming procedure in the forming chamber. Preferred sinter powder of the invention has, after heat-aging of the powder, a recrystallization temperature (a recrystallization peak) and/or an enthalpy of crystallization, which shifts) to higher values. It is preferable that both the recrystallization temperature and the enthalpy of crystallization shift to higher values. A powder of the invention which in the form of virgin powder has a recrystallization temperature above 138° C. very particularly preferably has, in the form of recycled powder obtained by aging for 7 days at 135° C., a recrystallization temperature higher, by from 0 to 3 K, preferably from 0.1 to 1 K, than the recrystallization temperature of the virgin powder.

The sinter powders of the invention are easy to produce. In the process of the invention, at least one polyamide is mixed with at least one metal soap, preferably with a powder of metal soap particles. For example, a polyamide powder obtained by reprecipitation or milling may be mixed, after suspension or solution in organic solvent, or in bulk, with metal soap particles; or the polyamide powder may be mixed in bulk with metal soap particles. In a preferred method for operating in a solvent, at least one metal soap or metal soap particles preferably at least to partially dissolved in a solvent, is mixed with a solution which comprises polyamide. Either the solution comprising the polyamide comprises the polyamide in dissolved form and the laser sinter powder is obtained by precipitation of polyamide from the solution comprising metal soap, or the solution comprises the polyamide suspended in powder form and the laser sinter powder is obtained by removing the solvent.

In a simple embodiment of the invention process, a wide variety of metals may be used to achieve fine-particle mixing. For example, the method of mixing may be the application of finely powdered metal soaps onto the dry polyamide powder by mixing in high-speed mechanical mixers, or wet mixing in low-speed assemblies, e.g. paddle dryers or circulating-screw mixers (known as Nauta mixers), or via dispersion of the metal soap and the polyamide powder in an organic solvent and subsequent removal of the solvent by distillation. In this procedure it is advantageous for the organic solvent to dissolve the metal soaps, at least at low concentration, because the metal soaps crystallize out in the form of very fine particles during drying, and encapsulate the polyamide grains. Examples of solvents suitable for this embodiment are lower alcohols having from 1 to 3 carbon atoms, preferably ethanol.

In one of the embodiments of the invention process, the polyamide powder is itself suitable as a laser sinter powder and fine metal soap particles are simply admixed with this powder. The metal soap particles preferably have a median particle size which is smaller or approximately equal to that of the particles of the polyamides. The extent to which the median particle size d₅₀ of the metal soap particles exceeds the median particle size d₅₀ of the polyamides should preferably be not more than 20%, with preference not more than 15%, and very particularly preferably not more than 5%. The particle size is limited by the overall height or thickness of the layer.

It is also possible to mix conventional sinter powders with sinter powders of the invention. This method can produce sinter powder with an ideal combination of mechanical and optical properties. The process for producing these mixtures may be found in DE 34 41 708 (incorporated herein by reference), for example.

In another version of the process, an incorporative compounding process is used to mix one or more metal soaps with a preferably molten polyamide, and the resultant polyamide-comprising metal soap is processed by (low-temperature) grinding or reprecipitation to give a laser sinter powder. The compounding usually gives pellets which are further processed to give sinter powder. Examples of methods for this conversion include milling or reprecipitation. The embodiment in which the metal soaps are incorporated by compounding has the advantage, when compared with the simple mixing process, of achieving more homogeneous dispersion of the metal soaps in the sinter powder.

In this case, a suitable flow aid, such as fumed aluminum oxide, fumed silicon dioxide, or fumed titanium dioxide, may be added to the precipitated or low-temperature-ground powder to improve flow performance.

In another, preferred embodiment of the process, the metal soap is admixed with an ethanolic solution of a polyamide before the precipitation of the polyamide is complete. This type of precipitation process has been described by way of example in DE 35 10 687 and DE 29 06 647 (each of which is incorporated herein by reference). This process may be used, for example, to precipitate nylon-12 from an ethanolic solution via controlled cooling according to a suitable temperature profile. In this procedure, the metal soaps likewise give a fine-particle encapsulation of the polyamide particles, as described above for suspension.

The person skilled in the art may also utilize this embodiment of the process in a modified form with other polyamides. The selection of polyamide and solvent may be such that the polyamide dissolves in the solvent at an elevated temperature and precipitates from the solution at a lower temperature and/or on removal of the solvent. The polyamide laser sinter powders of the invention are obtained by adding metal soaps, preferably in the form of particles, to this solution, and then drying.

Examples of metal soaps which may be used include salts of monocarboxylic acids. Commercially available products are available, for example, from the company Clariant with the trademark LICOMONT®.

To improve processability, or to further modify the sinter powder, the powder may be provided with inorganic color pigments, e.g. transition metal oxides, stabilizers, e.g. phenols, in particular sterically hindered phenols, flow aids, e.g. fumed silicas, and/or filler particles. The amount of these substances added to the polyamides, based on the total weight of the polyamides in the sinter powder, is preferably such as to comply with the concentrations given for fillers and/or auxiliaries for the sinter powder of the invention.

The present invention also provides processes for producing moldings by selective laser sintering, using the sinter powders of the invention in which polyamides and metal soaps, i.e. salts of the alkanemonocarboxylic acids, preferably in particulate form, are present. The present invention in particular provides a process for producing moldings by selective laser sintering of a precipitated powder based on a nylon-12 which has a melting point of from 185 to 189° C., an enthalpy of fusion of 112±17 kJ/mol, and a freezing point of from 136 to 145° C., the use of which is described in U.S. Pat. No. 6,245,281.

These processes are well-known, and are based on the selective sintering of polymer particles, where layers of polymer particles are briefly exposed to laser light, which results in polymer particles exposed to the laser light bonding to one another. Three-dimensional objects may be produced by successive sintering of layers of polymer particles. Details of the selective laser sintering process are found by way of example in U.S. Pat. No. 6,136,948 and WO 96/06881.

The moldings of the invention, produced by selective laser sintering, comprise a polyamide in which at least one metal soap is present. The moldings of the invention preferably comprise at least one polyamide which has at least 8 carbon atoms per carboxamide group. Moldings of the invention very particularly preferably comprise at least one of nylon-6,12, nylon-11, and/or one nylon-12, and at least one metal soap. The metal soap present in the molding of the invention is based on linear saturated alkanemonocarboxylic acids whose chain length is from C10 to C44, preferably from C24 to C36. The metal soaps are preferably calcium salts or sodium salts of saturated fatty acids, or of montanic acid. The molding of the invention preferably comprises, based on the entirety of the polyamides present in the molding, from 0.01 to 30% by weight of metal soaps, with preference from 0.1 to 20% by weight, particularly preferably from 0.5 to 15% by weight, and very particularly preferably from 1 to 10% by weight. The amount of metal soap may be present in any range or subrange included therein, for example, 1-2, 2-5, 5-10, 1-5% by weight etc.

The moldings may further comprise one or more fillers and/or auxiliaries, e.g. heat stabilizers and/or antioxidants, e.g. sterically hindered phenol derivatives. Examples of fillers include glass particles, ceramic particles, and also metal particles, such as iron shot, or hollow spheres thereof. The moldings of the invention preferably comprise glass particles, very particularly preferably glass beads. Moldings of the invention preferably comprise less than 3% by weight, with preference from 0.001 to 2% by weight, and very particularly preferably from 0.05 to 1% by weight, of these auxiliaries, based on the total amount of the polyamide present. Moldings of the invention also preferably comprise less than 75% by weight, with preference from 0.001 to 70% by weight, particularly preferably from 0.05 to 50% by weight, and very particularly preferably from 0.5 to 25% by weight, of these fillers, based on the total weight of the polyamides present.

Another method of producing the moldings of the invention uses a sinter powder of the invention in the form of an aged material (aging as described above), where neither the recrystallization peak nor the enthalpy of crystallization is smaller than that of the unaged material. Preference is given to the preparation of a molding which uses an aged material which has a higher recrystallization peak and a higher enthalpy of crystallization than the unaged material. Despite the use of recycled powder, the moldings have properties almost the same as those of moldings produced from virgin powder.

The examples below are intended to describe the sinter powder of the invention and its use without further limiting the invention.

The BET surface area determination carried out in the examples below complied with DIN 66131. The bulk density was determined using an apparatus to DIN 53466. The values measured for laser scattering were obtained on a Malvern Mastersizer S, Version 2.18.

### EXAMPLE 1

### Incorporation of Sodium Montanate by Reprecipitation

40 kg of unregulated PA 12 prepared by hydrolytic polymerization (the preparation of this polyamide being described by way of example in DE 21 52 194, DE 25 46 267, or DE 35 1 0690, each of which is incorporated herein by reference), with relative solution viscosity η_{rel.} of 1.61 (in acidified m-cresol) and having an end group content of 72 mmol/kg of COOH and, respectively, 68 mmol/kg of NH₂ are heated to 145° C. within a period of 5 hours in a 0.8 m³ stirred tank (D=90 cm, h=170 cm) with 0.3 kg of IRGANOX® 1098 and 0.8 kg of sodium montanate (Licomont® NAV101), and also 350 l of ethanol, denatured with 2-butanone and 1% water content, and held at this temperature for 1 hour, with stirring (blade stirrer, d=42 cm, rotation rate=91 rpm). The jacket temperature was then reduced to 120° C., and the internal temperature was brought to 120° C. at a cooling rate of 45 K/h, using the same stirrer rotation rate. From this juncture onward, the jacket temperature was held at from 2 to 3 K below the internal temperature, using the same cooling rate. The internal temperature was brought to 117° C., using the same cooling rate, and then held constant for 60 minutes. The internal temperature was then brought to 111° C., using a cooling rate of 40 K/h. At this temperature the precipitation begins and is detectable via evolution of heat. After 25 minutes the internal temperature fell, indicating the end of the precipitation. After cooling of the suspension to 75° C., the suspension was transferred to a paddle dryer. The ethanol was distilled off from the material at 70° C. and 400 mbar, with stirring, and the residue is then further dried at 20 mbar and 85° C. for 3 hours. A sieve analysis is carried out on the resultant product and gave the following result:

| | | |
|---|---|---|
| Sieve analysis: | <32 μm: | 8% by weight |
| | <40 μm: | 17% by weight |
| | <50 μm: | 46% by weight |
| | <63 μm | 85% by weight |
| | <80 μm: | 95% by weight |
| | <100 μm: | 100% by weight |
| BET: | 6.8 m²/g | |
| Bulk density: | 433 g/l | |

| | |
|---|---|
| Laser scattering: | d(10%): 44 μm, d(50%): 69 μm, |
| | d(90%): 97 μm. |

### EXAMPLE 2

### Incorporation of Sodium Montanate by Compounding and Reprecipitation

40 kg of unregulated PA 12 prepared by hydrolytic polymerization with a relative solution viscosity η_{rel.} of 1.61 (in acidified m-cresol) and with an end group content of 72 mmol/kg of COOH and, respectively, 68 mmol/kg of NH² are extruded with 0.3 kg of IRGANOX® 245 and 0.8 kg of sodium montanate (Licomont® NAV101) at 225° C. in a twin-screw compounder (Bersttorf ZE25), and strand-pelletized. This compounded material was then brought to 145° C. within a period of 5 hours in a 0.8 m³ stirred tank (D=90 cm, h=170 cm) with 350 l of ethanol, denatured with 2-butanone and 1% water content, and held at this temperature for 1 hour, with stirring (blade stirrer, d=42 cm, rotation rate=91 rpm). The jacket temperature was then reduced to 120° C., and the internal temperature is brought to 120° C. at a cooling rate of 45 K/h, using the same stirrer rotation rate. From this juncture onward, the jacket temperature was held at from 2 to 3 K below the internal temperature, using the same cooling rate. The internal temperature was brought to 117° C., using the same cooling rate, and then held constant for 60 minutes. The internal temperature was then brought to 111° C., using a cooling rate of 40 K/h. At this temperature the precipitation began and was detectable via evolution of heat. After 25 minutes the internal temperature fell, indicating the end of the precipitation. After cooling of the suspension to 75° C., the suspension was transferred to a paddle dryer. The ethanol was distilled off from the material at 70° C. and 400 mbar, with stirring, and the residue was then further dried at 20 mbar and 85° C. for 3 hours. A sieve analysis was carried out on the resultant product and gave the following result:

| | | |
|---|---|---|
| Sieve analysis: | <32 μm: | 11% by weight |
| | <40 μm: | 18% by weight |
| | <50 μm: | 41% by weight |
| | <63 μm | 83% by weight |
| | <80 μm: | 99% by weight |
| | <100 μm: | 100% by weight |
| BET: | 7.3 m²/g | |
| Bulk density: | 418 g/l | |

| | |
|---|---|
| Laser scattering: | d(10%): 36 μm, d(50%): 59 μm, |
| | d(90%): 78 μm. |

### EXAMPLE 3

### Incorporation of Sodium Montanate in Ethanolic Suspension

The procedure was as described in example 1, but the metal soap is not added at the start, but 0.4 kg of sodium montanate (Licomont® NAV101) was added at 75° C. to the freshly precipitated suspension in the paddle dryer, once the precipitation is complete. Drying and further work-up took place as described in example 1.

| | | |
|---|---|---|
| Sieve analysis: | <32 μm: | 6% by weight |
| | <40 μm: | 19% by weight |
| | <50 μm: | 44% by weight |
| | <63 μm | 88% by weight |
| | <80 μm: | 94% by weight |
| | <100 μm: | 100% by weight |
| BET: | 5.9 m²/g | |
| Bulk density: | 453 g/l | |

| | |
|---|---|
| Laser scattering: | d(10%): 47 μm, d(50%): 63 μm, |
| | d(90%): 99 μm. |

### EXAMPLE 4

### Incorporation of Calcium Montanate in Ethanolic Suspension

The procedure was as described in example 3, but 0.4 kg of calcium montanate (Licomont® CAV102P) was added at 75° C. to the freshly precipitated suspension in the paddle dryer, and the drying process described in example 1 is completed.

| | | |
|---|---|---|
| Sieve analysis: | <32 μm: | 6% by weight |
| | <40 μm: | 17% by weight |
| | <50 μm: | 49% by weight |
| | <63 μm | 82% by weight |
| | <80 μm: | 97% by weight |
| | <100 μm: | 100% by weight |
| BET: | 5.4 m²/g | |
| Bulk density: | 442 g/l | |

| | |
|---|---|
| Laser scattering: | d(10%): 49 μm, d(50%): 66 μm, |
| | d(90%): 94 μm. |

### EXAMPLE 5

### Incorporation of Magnesium Stearate in Ethanolic Suspension

The procedure was as described in example 3, but 0.4 kg of magnesium montanate (1% by weight) was added at 75° C. to the freshly precipitated suspension in the paddle dryer, and the drying process described in example 1 is completed.

| | | |
|---|---|---|
| Sieve analysis: | <32 μm: | 5% by weight |
| | <40 μm: | 14% by weight |
| | <50 μm: | 43% by weight |
| | <63 μm | 89% by weight |
| | <80 μm: | 91% by weight |
| | <100 μm: | 100% by weight |
| BET: | 5.7 m²/g | |
| Bulk density: | 447 g/l | |

| | |
|---|---|
| Laser scattering: | d(10%): 44 μm, d(50%): 59 μm, |
| | d(90%): 91 μm. |

### EXAMPLE 6

### Incorporation of Sodium Montanate by Reprecipitation

40 kg of unregulated PA 12, as in example 1, were brought to 145° C. within a period of 5 hours in a 0.8 m³ stirred tank (D=90 cm, h=170 cm) with 0.2 kg of Lowinox BHT® (=2,6-di-tert-butyl-4-methylphenol) and 0.4 kg (1% by weight) of sodium montanate (Licomont® NAV101), with 350 l of ethanol, denatured with 2-butanone and 1% water content, and held at this temperature for 1 hour, with stirring (blade stirrer, d=42 cm, rotation rate=89 rpm). The jacket temperature was then reduced to 120° C., and the internal temperature was brought to 125° C. at a cooling rate of 45 K/h, using the same stirrer rotation rate. From this juncture onward, the jacket temperature was held at from 2 to 3 K below the internal temperature, using the same cooling rate. The internal temperature was brought to 117° C., using the same cooling rate, and then held constant for 60 minutes. The internal temperature was then brought to 110° C., using a cooling rate of 40 K/h. At this temperature the precipitation begins and was detectable via evolution of heat. After 20 minutes the internal temperature fell, indicating the end of the precipitation. After cooling of the suspension to 75° C., the suspension was transferred to a paddle dryer. The ethanol was distilled off from the material at 70° C. and 400 mbar, with stirring, and the residue was then further dried at 20 mbar and 85° C. for 3 hours.

| | | |
|---|---|---|
| Sieve analysis: | <32 μm: | 4% by weight |
| | <40 μm: | 19% by weight |
| | <50 μm: | 44% by weight |
| | <63 μm | 83% by weight |
| | <80 μm: | 91% by weight |
| | <100 μm: | 100% by weight |
| BET: | 6.1 m²/g | |
| Bulk density: | 442 g/l | |

| | |
|---|---|
| Laser scattering: | d(10%): 44 μm, d(50%): |
| | 68 μm, d(90%): 91 μm. |

### EXAMPLE 7

### Incorporation of Calcium Montanate by Reprecipitation

40 kg of unregulated PA 12, as in example 1, were brought to 145° C. within a period of 5 hours in a 0.8 m³ stirred tank (D=90 cm, h=170 cm) with 0.2 kg of Lowinox TBP6® (=4,4′thiobis(2-tert-butyl-5-methylphenol) and 0.4 kg (1% by weight) of calcium montanate (Licomont® CAV102P), with 350 l of ethanol, denatured with 2-butanone and 1% water content, and held for 1 hour at this temperature, with stirring (blade stirrer, d=42 cm, rotation rate=90 rpm). The jacket temperature was then reduced to 120° C., and the internal temperature was brought to 125° C. at a cooling rate of 45 K/h, using the same stirrer rotation rate. From this juncture onward, the jacket temperature was held at from 2 to 3 K below the internal temperature, using the same cooling rate. The internal temperature was brought to 117° C., using the same cooling rate, and then held constant for 60 minutes. The internal temperature was then brought to 110° C., using a cooling rate of 40 K/h. At this temperature the precipitation begins and was detectable via evolution of heat. After 20 minutes the internal temperature falls, indicating the end of the precipitation. After cooling of the suspension to 75° C., the suspension was transferred to a paddle dryer. The ethanol was distilled off from the material at 70° C. and 400 mbar, with stirring, and the residue was then further dried at 20 mbar and 85° C. for 3 hours.

| | | |
|---|---|---|
| Sieve analysis: | <32 μm: | 7% by weight |
| | <40 μm: | 18% by weight |
| | <50 μm: | 47% by weight |
| | <63 μm | 85% by weight |
| | <80 μm: | 92% by weight |
| | <100 μm: | 100% by weight |
| BET: | 6.6 m²/g | |
| Bulk density: | 441 g/l | |

| | |
|---|---|
| Laser scattering: | d(10%): 43 μm, d(50%): |
| | 69 μm, d(90%): 94 μm. |

### EXAMPLE 8

### Dry Blend Incorporation of Zinc Stearate

20 g (1 part) of zinc stearate were mixed for 3 minutes at 50° C. and 700 rpm with 2 kg (100 parts) of nylon-12 powder prepared as in DE 29 06 647 with a median particle diameter d₅₀ of 57 μm (laser scattering) and with a bulk density of 460 g/l to DIN 53466, in a dry-blend process utilizing a FML10/KM23 Henschel mixer. 2 g of Aerosil 200 (0.1 part) were then incorporated for 3 minutes at room temperature and 500 rpm.

### EXAMPLE 9

### Dry Blend Incorporation of Calcium Montanate

60 g (3 parts) of calcium montanate together with 1 g of Aerosil 200 (0.05 part) were mixed for 3 minutes at room temperature and 400 rpm with 2 kg (100 parts) of nylon-12 powder prepared, as in DE 29 06 647 with a median particle diameter d₅₀ of 65 μm (laser scattering) and with a bulk density of 472 g/l to DIN 53466, in a dry-blend process utilizing a FML10/KM23 Henschel mixer.

### EXAMPLE 10

### Dry Blend Incorporation of Calcium Stearate

10 g (0.5 part) of calcium stearate were mixed for 5 minutes at room temperature and 400 rpm with 2 kg (100 parts) of nylon-12 powder prepared as in DE 29 06 647 with a median particle diameter d₅₀ of 48 μm (laser scattering) and with a bulk density of 450 g/l to DIN 53466, in a dry-blend process utilizing a FML10/KM23 Henschel mixer.

### EXAMPLE 11

### Comparative Example

### Non-Inventive

40 kg of unregulated PA 12 prepared by hydrolytic polymerization, with a relative solution viscosity η_{rel.} of 1.61 (in acidified m-cresol) and with an end group content of 72 mmol/kg of COOH and, respectively, 68 mmol/kg of NH₂ were brought to 145° C. within a period of 5 hours in a 0.8 m³ stirred tank (D=90 cm, h=170 cm) with 0.3 kg of IRGANOX® 1098 in 350 l of ethanol denatured with 2-butanone and 1% water content, and held at this temperature for 1 hour, with stirring (blade stirrer, d=42 cm, rotation rate=91 rpm). The jacket temperature was then reduced to 120° C., and the internal temperature was brought to 120° C. at a cooling rate of 45 K/h, using the same stirrer rotation rate. From this juncture onward, the jacket temperature was held at from 2 to 3 K below the internal temperature, using the same cooling rate. The internal temperature was brought to 117° C., using the same cooling rate, and then held constant for 60 minutes. The internal temperature is then brought to 111° C., using a cooling rate of 40 K/h. At this temperature the precipitation begins and was detectable via evolution of heat. After 25 minutes the internal temperature falls, indicating the end of the precipitation. After cooling of the suspension to 75° C., the suspension was transferred to a paddle dryer. The ethanol was distilled off from the material at 70° C. and 400 mbar, with stirring, and the residue was then further dried at 20 mbar and 85° C. for 3 hours.

| | | |
|---|---|---|
| Sieve analysis: | <32 μm: | 7% by weight |
| | <40 μm: | 16% by weight |
| | <50 μm: | 46% by weight |
| | <63 μm | 85% by weight |
| | <80 μm: | 92% by weight |
| | <100 μm: | 100% by weight |
| BET: | 6.9 m²/g | |
| Bulk density: | 429 g/l | |

| | |
|---|---|
| Laser scattering: | d(10%): 42 μm, d(50%): |
| | 69 μm, d(90%): 91 μm. |

### Further Processing and Aging Tests:

All of the specimens from examples 1 to 7 and 11 were treated with 0.1% by weight of Aerosil 200 for, 1 minute in a CM50 D Mixaco mixer at 150 rpm. Portions of the powders obtained from examples 1 to 11 were aged at 135° C. for 7 days in a vacuum drying cabinet and then, with no addition of fresh powder, used to form a structure on a laser sintering machine. Mechanical properties of the components were determined by tensile testing to EN ISO 527 (table 1). Density was determined by a simplified internal method. For this, the test specimens produced to ISO 3167 (multipurpose test specimens) were measured, and these measurements were used to calculate the volume, and the weight of the test specimens was determined, and the density was calculated from volume and weight. Components and test specimens to ISO 3167 were also produced from virgin powder (unaged powder) for comparative purposes. In each case, an EOSINT P360 laser sintering machine from the company EOS GmbH was used for the production process.

TABLE 1
Mechanical properties of artificially aged powder
in comparison with unaged powder

| | Tensile | Modulus of | |
|---|---|---|---|
| | strain at | elasticity in | Density in |
| | break in % | N/mm² | g/cm³ |
| Parts composed of standard powder | 21.2 | 1641 | 0.96 |
| as in example 11, unaged | | | |
| Parts composed of standard powder | 9.4 | 244 | 0.53 |
| as in example 11, aged | | | |
| Parts from example 3, unaged | 18.9 | 1573 | 0.95 |
| Parts from example 1, aged | 19.5 | 1640 | 0.95 |
| Parts from example 2, aged | 18.6 | 1566 | 0.95 |
| Parts from example 3, aged | 19.8 | 1548 | 0.94 |
| Parts from example 4, aged | 18.1 | 1628 | 0.95 |
| Parts from example 5, aged | 14.2 | 1899 | 0.97 |
| Parts from example 6, aged | 19.6 | 1560 | 0.94 |
| Parts from example 7, aged | 21.8 | 1558 | 0.95 |
| Parts from example 8, aged | 15.2 | 1731 | 0.96 |
| Parts from example 9, aged | 15.6 | 1734 | 0.95 |
| Parts from example 10, aged | 5.6 | 1664 | 0.96 |

As can be seen from table 1, the admixture of metal soaps achieves the improvements described below. The result of the modification is that the density after aging remains approximately at the level for a virgin powder. Mechanical properties, such as tensile strain at break and modulus of elasticity, also remain at a high level despite aging of the powder.

### Recycling Test

A powder produced as in example 3, and a comparative powder produced as in the comparative example, in each case with no artificial aging, were also recycled on a laser sintering machine (EOSINT P360 from the company EOS GmbH). This means that powder which has been used but not sintered is reused in the next forming process. After each pass, the reused powder was supplemented by adding 20% of fresh, unused powder. The mechanical properties of the components were determined by tensile testing to EN ISO 527. Density was determined as described above by the simplified internal method. Table 2 lists the values measured on components obtained by recycling.

TABLE 2
Recycling

| | Material from example 3 | | | Comparative example | | |
|---|---|---|---|---|---|---|
| | | Modulus | | | Modulus | |
| | Component | of | Tensile | Component | of | Tensile |
| | density | elasticity | strain at | density | elasticity | strain at |
| | [g/cm³] | [MPa] | break [%] | [g/cm³] | [MPa] | break [%] |
| 1^{st} pass | 0.95 | 1573 | 18.9 | 0.95 | 1603 | 17.8 |
| 3^{rd} pass | 0.96 | 1595 | 21.5 | 0.88 | 1520 | 15.2 |
| 6^{th} pass | 0.97 | 1658 | 29 | 0.8 | 1477 | 14.9 |

It is seen from table 2 that even on the 8th pass there is no deterioration in either the density, or the mechanical properties of the component produced from a powder of the invention. In contrast, the density and the mechanical properties of the component produced from the comparative powder fall away markedly as the number of passes increases.

In a further study of powder of the invention, DSC equipment (Perkin Elmer DSC 7) was used for DSC studies to DIN 53765, both on powder produced according to the invention and on specimens of components. The results of these studies are given in table 3. In the “process of” column the process used to produce the powders is given, and the column “metal soap” in each case states whether, which, and how much, metal soap was used in producing the powder. The components again comply with ISO 3167, and were obtained as described above. Characteristic features of the powders of the invention and, respectively, of components produced from the powder of the invention, are an enthalpy of fusion increased over that of the unmodified powder, and a markedly increased recrystallization temperature. There is also a rise in enthalpy of crystallization. The values relate to powder artificially aged as described above and, respectively, to components produced from this aged powder.

TABLE 3
Values from DSC measurement

| | 1^{st} heating | Cooling | Cooling | 2^{nd} heating | |
|---|---|---|---|---|---|
| | Enthalpy of | Recrystallization | Enthalpy of | Enthalpy of | |
| | fusion | peak | crystallization | fusion | |
| | ΔH_{F} | T_{CP} | ΔH_{C} | ΔH_{F} | |
| Metal soap | J/g | ° C. | J/g | J/g | Process of |
| Component (composed | | | | | |
| of artificially aged | | | | | |
| powder) | | | | | |
| 1% of Licomont NaV | 92 | 138 | 65 | 73 | Example 3 |
| 101 | | | | | |
| 2% of Licomont NaV | 95 | 139 | 69 | 74 | Example 3 |
| 101 | | | | | |
| 3% of Licomont NaV | 88 | 140 | 70 | 70 | Example 3 |
| 101 | | | | | |
| 5% of Licomont NaV | 88 | 140 | 70 | 72 | Example 3 |
| 101 | | | | | |
| 1% of Zn stearate | 97 | 138 | 70 | 78 | Example 8 |
| 1% of Ca stearate | 99 | 139 | 69 | 71 | Example 8 |
| 1% of Mg stearate | 101 | 139 | 70 | 73 | Example 8 |
| Standard material | 88 | 131 | 58 | 60 | Example 11 |
| Component (composed | | | | | |
| of unaged powder | | | | | |
| Standard material | 106 | 136 | 63 | 67 | Example 11 |

As can be seen from the table, the components derived from aged powder modified according to the invention have crystallinity properties similar to those of the components derived from an unaged powder, whereas the component composed of aged comparative powder (standard material) has markedly different properties. When recrystallization temperature and enthalpy of crystallization are considered, it can also be seen that the powder comprising metal soaps, when used as recycled powder, has the same, or even a higher, recrystallization temperature and enthalpy of crystallization when compared with the untreated virgin powder. In contrast, in the case of the untreated recycled powder, the recrystallization temperature and the enthalpy of crystallization are lower than those of the virgin powder.

German applications 10255793.4 and 10330591.2 filed on Nov. 28, 2002 and Jul. 7, 2003, respectively, are each incorporated herein by reference in their entireties.

Obviously, numerous modifications and variations of the present invention are possible in light of the above teachings. It is therefore to be understood that within the scope of the appended claims, the invention may be practiced otherwise than as specifically described herein.

What we claim is:

1. A sinter powder, consisting of at least one polyamide and at least one metal soap selected from the group consisting of a salt of a fatty acid having at least 10 carbon atoms, a salt of montanic acid and a salt of a dimer acid, the powder producing molded articles when subjected to selective laser sintering.

2. The sinter powder as claimed in claim 1, wherein the polyamide has at least 8 carbon atoms per carboxamide group.

3. The sinter powder as claimed in claim 1, which comprises at least one of nylon-6,12, nylon-11, or nylon-12, or a copolyamide thereof.

4. The sinter powder as claimed in claim 1, wherein the metal soap is present in an amount of 0.01 to 30% by weight, based on the total weight of the at least one polyamide present in the powder.

5. The sinter powder as claimed in claim 4, wherein the metal soap is present in an amount of 0.5 to 15% by weight.

6. The sinter powder as claimed in claim 1, wherein the metal soap and the polyamide are present as a mixture of fine particles.

7. The sinter powder as claimed in claim 1, wherein the metal soap is incorporated within particles of the polyamide.

8. The sinter powder as claimed in claim 1, wherein the metal soap is an alkali metal or alkaline earth metal salt of an alkanemonocarboxylic acid or a dimer acid.

9. The sinter powder as claimed in claim 1, wherein the recrystallization peak, the enthalpy of crystallization of the powder, or both, does not have a smaller value after heat-aging than the value before heat aging.

10. The sinter powder as claimed in claim 1, wherein the recrystallization peak, the enthalpy of crystallization, or both, does not have a higher value after heat-aging than the value before heat aging.

11. The sinter powder as claimed in claim 1, wherein the metal soap is a sodium or calcium salt of an alkanemonocarboxylic acid or a dimer acid.

12. The sinter powder as claimed in claim 1, wherein the polyamide is one that has 9 or more carbon atoms per carboxamide group.

13. A process for producing the sinter powder as claimed in claim 1, which comprises:
mixing at least one polyamide with at least one metal soap.

14. The process as claimed in claim 13, wherein a polyamide powder obtained by reprecipitation or milling is mixed with metal soap particles, after suspension or solution in an organic solvent, or in bulk.

15. The process as claimed in claim 13, wherein the metal soaps are compounded by mixing the metal soaps into a melt of the polyamide to form a mixture.

16. The process as claimed in claim 13, wherein the mixture is processed by precipitation or milling to give the sinter powder.

17. The process as claimed in claim 13, wherein at least one metal soap or metal soap particles is mixed with a solution comprising a polyamide, wherein when the solution comprises the polyamide in dissolved form the laser sinter powder is obtained by precipitation, or when the solution comprises the polyamide suspended in powder form the laser sinter powder is obtained by removing the solvent.

18. A process for producing moldings, comprising:
selective laser sintering the sinter powder as claimed in claim 1.

19. A molding produced by laser sintering the sinter powder of claim 1.

20. The molding as claimed in claim 19, wherein the polyamide has at least 8 carbon atoms per carboxamide group.

21. The molding as claimed in claim 19, comprising at least one polyamide selected from the group consisting of nylon-6,12, nylon-11 and nylon-12.

22. The molding as claimed in claim 19, wherein the metal soap is present in an amount of from 0.01 to 30% by weight based on the total weight of the at least one polyamide.

23. The molding as claimed in claim 22, wherein the metal soap is present in an amount of from 0.5 to 15% by weight based on the total weight of the at least one polyamide.

24. The molding as claimed in claim 19, wherein the metal soap is a sodium or calcium salt of an alkanemonocarboxylic acid.

25. A sinter powder, consisting of at least one polyamide, at least one metal soap selected from the group consisting of a salt of a fatty acid having at least 10 carbon atoms, a salt of montanic acid and a salt of a dimer acid, at least one filler, flow aid and/or auxiliary, the powder producing molded articles when subjected to selective laser sintering.

26. The sinter powder as claimed in claim 25, wherein the polyamide is one that has 9 or more carbon atoms per carboxamide group.

27. The sinter powder as claimed in claim 26, wherein said filler is glass particles.

28. The molding as claimed in claim 19, obtained by laser sintering an aged sinter powder wherein neither the recrystallization peak nor the enthalpy of crystallization is smaller than the recrystallization peak or enthalpy of crystallization for an unaged sinter powder.
